(19) United States
(12) Patent Application Publication
(10) Pub. No.: US 2025/0380193 A1
(43) Pub. Date: Dec. 11, 2025

(54) METHOD AND APPARATUS FOR PATH SWITCH

(71) Applicant: LENOVO (BEIJING) LIMITED, Beijing (CN)

(72) Inventors: Lianhai WU, Beijing (CN); Mingzeng DAI, Shanghai (CN); Congchi ZHANG, Shanghai (CN); Le YAN, Shanghai (CN); Haiming WANG, Beijing (CN)

(21) Appl. No.: 18/875,585

(22) PCT Filed: Jun. 17, 2022
(86) PCT No.: PCT/CN2022/099555

§ 371 Date: Dec. 16, 2024

(51) Int. Cl. H04W 36/00; H04W 76/19; H04W 76/20; H04W 76/30; H04W 92/18

(52) U.S. Cl. CPC H04W 36/0069; H04W 76/19; H04W 76/20; H04W 76/30; H04W 92/18

(57) ABSTRACT

Embodiments of the present disclosure relate to methods and apparatuses for path switch in a communication system. According to some embodiments of the disclosure, a UE may: communicate with a BS via a relay node; receive, via the relay node from the BS, an RRC reconfiguration message for a DAPS path switch from a source connection to a target connection; and start a timer for path switch in response to receiving the RRC reconfiguration message.

### TECHNICAL FIELD

Embodiments of the present disclosure generally relate to communication technology, and more particularly to path switch in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay node (e.g., a relay UE). In the context of the present disclosure, a UE, which functions as a relay between another UE and a BS, may be referred to as a UE-to-network (U2N) relay.

There is a need for efficiently performing communication in a communication system supporting a U2N relay.

### SUMMARY

Some embodiments of the present disclosure provide a user equipment (UE). The UE may include: a transceiver; and a processor coupled to the transceiver. The processor may be configured to: communicate with a base station (BS) via a relay node; receive, via the relay node from the BS, a radio resource control (RRC) reconfiguration message for a dual active protocol stack (DAPS) path switch from a source connection to a target connection; and start a timer for path switch in response to receiving the RRC reconfiguration message.

Some embodiments of the present disclosure provide a relay node. The relay node may include: a transceiver; and a processor coupled to the transceiver. The processor may be configured to: establish a PC5 connection for a link between a user equipment (UE) and the relay node, wherein the UE communicates with a base station (BS) via the relay node; and receive, from the BS or the UE, information associated with a dual active protocol stack (DAPS) path switch for the UE.

In some embodiments of the present disclosure, the information may be received from the BS, and indicate at least one of the following: whether a bearer associated with the relay node and the UE should be suspended or continued; or a DAPS path switch is performed at the UE.

In some embodiments of the present disclosure, to indicate whether a bearer associated with the relay node and the UE should be suspended or continued, the information may include an indication indicating whether the bearer is associated with the DAPS path switch or not.

In some embodiments of the present disclosure, the processor may be further configured to, in response to receiving the information, perform at least one of the following: continue communications associated with the bearer in the case that the information indicates that the bearer is associated with the DAPS path switch; or release data associated with the bearer in the case that the information indicates that the bearer is not associated with the DAPS path switch.

In some embodiments of the present disclosure, the processor may be further configured to, after receiving the information, transmit a PC5 unicast link release indication to the UE in response to one of the following conditions: an RLF between the relay node and the BS; a reception of an RRC reconfiguration message including a configuration with synchronization at the relay node; a cell reselection at the relay node; an RRC connection establishment failure or an RRC resume failure at the relay node; an initiation of a reestablishment procedure at the relay node; a successful reestablishment procedure at the relay node; a failed reestablishment procedure at the relay node; and a successful handover of the relay node.

In some embodiments of the present disclosure, the information may be received from the UE and indicate a fallback of the DAPS path switch. In some embodiments of the present disclosure, the information may be received from the BS and indicate a fallback of the DAPS path switch and an ID of the UE.

In some embodiments of the present disclosure, the information may be received from the UE via an RRC layer or sidelink relay adaptation protocol (SRAP) layer. In some embodiments of the present disclosure, the information may be received from the BS via an RRC message.

In some embodiments of the present disclosure, the processor may be further configured to revert a bearer not associated with the DAPS path switch back to a source configuration in response to receiving the information.

Some embodiments of the present disclosure provide a base station (BS). The BS may include: a transceiver; and a processor coupled to the transceiver. The processor may be configured to: transmit, to a user equipment (UE) via a relay node, a radio resource control (RRC) reconfiguration message for a dual active protocol stack (DAPS) path switch; and transmit, to the relay node, information associated with the DAPS path switch.

In some embodiments of the present disclosure, the information may indicate at least one of the following: whether a bearer associated with the relay node and the UE should be suspended or continued; or a DAPS path switch is performed at the UE.

In some embodiments of the present disclosure, to indicate whether a bearer associated with the relay node and the UE should be suspended or continued, the information may include an indication indicating whether the bearer is associated with the DAPS path switch or not.

In some embodiments of the present disclosure, the processor may be configured to receive a failure indication of the DAPS path switch from the UE. The information may be transmitted in response to receiving the failure indication, and indicate a fallback of the DAPS path switch and an ID of the UE. In some embodiments of the present disclosure, the information may be transmitted via an RRC message.

In some embodiments of the present disclosure, the processor may be further configured to receive capability information indicating whether the UE supports a DAPS path switch or not.

The capability information may indicate at least one of the following: whether the UE supports a path switch from an indirect path to a direct path or not; or whether the UE supports a path switch from an indirect path to another indirect path or not.

Some embodiments of the present disclosure provide a method performed by a user equipment (UE). The method may include: communicating with a base station (BS) via a relay node; receiving, via the relay node from the BS, a radio resource control (RRC) reconfiguration message for a dual active protocol stack (DAPS) path switch from a source connection to a target connection; and starting a timer for path switch in response to receiving the RRC reconfiguration message.

Some embodiments of the present disclosure provide a method performed by a relay node. The method may include: establishing a PC5 connection for a link between a user equipment (UE) and the relay node, wherein the UE communicates with a base station (BS) via the relay node; and receiving, from the BS or the UE, information associated with a dual active protocol stack (DAPS) path switch for the UE.

Some embodiments of the present disclosure provide a method performed by a relay node. The method may include: transmitting, to a user equipment (UE) via a relay node, a radio resource control (RRC) reconfiguration message for a dual active protocol stack (DAPS) path switch; and transmitting, to the relay node, information associated with the DAPS path switch.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in in accordance with some embodiments of the present disclosure;

FIG. 2 illustrates a schematic diagram of a relay based wireless communication system in accordance with some embodiments of the present disclosure;

FIG. 3 illustrates a flow chart of an exemplary notification message procedure in accordance with some embodiments of the present disclosure;

FIG. 4 illustrates a schematic diagram of a wireless communication system in accordance with some embodiments of the present disclosure;

FIGS. 5-9 illustrate flow charts of exemplary procedures of wireless communications in accordance with some embodiments of the present disclosure; and

FIG. 10 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

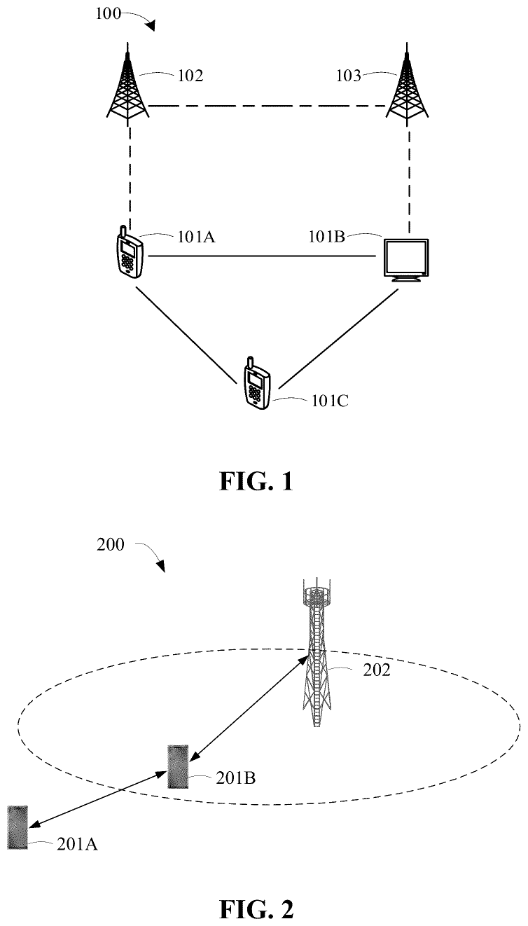

FIG. 1 illustrates a schematic diagram of wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP TS 38 series specification) may refer to access stratum (AS) functionality enabling at least vehicle-to-everything (V2X) communications between neighboring UEs, using NR technology but not traversing any network node. V2X sidelink communications (e.g., specified in 3GPP TS 36 series specification) may refer to AS functionality enabling V2X communications between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BS, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. A Sidelink relay can provide connectivity to the network for another UE (remote UE). In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be respectively referred to as the serving BS or serving cell of the remote UE.

A remote UE may have RRC states, such as an RRC_IDLE state, an RRC INACTIVE state, and an RRC_CONNECTED state as defined in 3GPP specifications. A relay UE may be in an RRC_CONNECTED state to perform relaying of unicast data. In some embodiments, in a path switch case, a relay UE in an RRC IDLE, RRC_INACTIVE or RRC_CONNECTED state can be selected as a target relay UE.

In some embodiments, the following RRC state combinations may be supported for a Layer-2 (L2) U2N Relay operation:
Both the relay UE and the remote UE may be in an RRC_CONNECTED state to perform transmission or reception of relayed unicast data; and
The relay UE can be in an RRC_IDLE, RRC_INACTIVE or RRC CONNECTED state as long as every remote UE that is connected to the relay UE is either in an RRC INACTIVE state or in an RRC IDLE state.

A single unicast link may be established between one relay UE and one remote UE. The traffic of the remote UE via a given relay UE and the traffic of the relay UE may be separated in different Uu relay radio link control (RLC) channels. In some embodiments, for the L2 U2N relay, the remote UE may only be configured to use resource allocation mode 2 for data to be relayed.

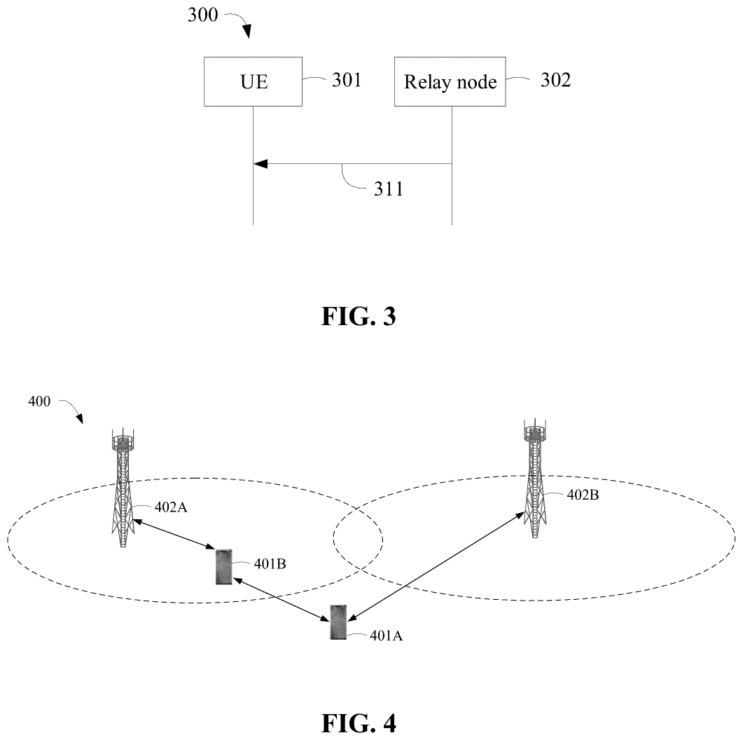

FIG. 2 illustrates a schematic diagram of relay-based wireless communication system 200 in accordance with some embodiments of the present disclosure. Details described in all of the foregoing embodiments of the present disclosure are applicable for the embodiments shown in FIG. 2.

As shown in FIG. 2, wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may also be referred to as a remote UE and UE 201B may also be referred to as a relay UE, a sidelink relay, or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

In some embodiments of the present disclosure, a relay node (e.g., a relay UE) may declare a Uu RLF (e.g., an RLF between the relay node and the BS) based on at least one of the following criteria:
the expiry of a radio problem timer started after the indication of radio problems from the physical layer (if the radio problems are recovered before the timer is expired, the relay node stops the timer); or
the expiry of a timer started upon triggering a measurement report for a measurement identity for which the timer has been configured while another radio problem timer is running; or
a random access procedure failure; or
an RLC failure.

In some embodiments of the present disclosure, in response to the declaration of the Uu RLF, the relay node may transmit a notification message to its connected remote UE(s), which may trigger an RRC connection reestablishment for the remote UE(s). In some embodiments of the present disclosure, the remote UE may trigger an RRC connection reestablishment in response to detecting a PC5 RLF (e.g., an RLF between the relay node and the remote UE).

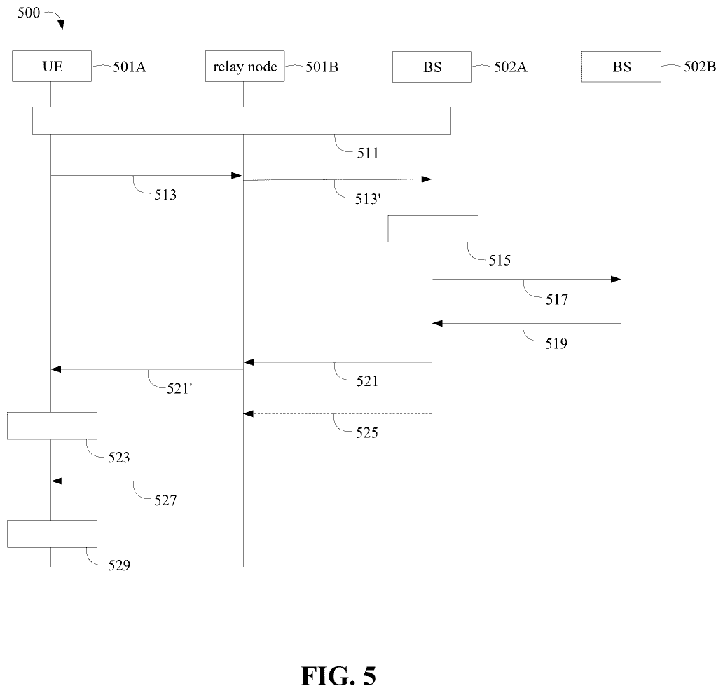

FIG. 3 illustrates a flow chart of exemplary notification message procedure 300 in accordance with some embodiments of the present disclosure. Details described in all of the foregoing embodiments of the present disclosure are applicable for the embodiments shown in FIG. 3.

Referring to FIG. 3, in operation 311, relay node 302 may transmit a notification message to UE 301. In some examples, relay node 302 may be a relay UE such as a U2N relay UE. In this scenario, the notification message may also be referred to as a “notification message for sidelink”.

In some embodiments of the present disclosure, relay node 302 may initiate exemplary procedure 300 when, for example, one of the following conditions is met:
in response to a Uu RLF as described above;
in response to the reception of an RRC reconfiguration message including a reconfiguration WithSync information element (IE), such as a handover command;
in response to cell reselection at relay node 302;
in response to an RRC connection failure at relay node 302, which may include, for example, an RRC connection rejection, an expiry of a timer for an RRC setup request (e.g., T300 as specified in 3GPP specifications), and an RRC resume failure.

The notification message may include a type indication (e.g., “indicationType”), which may indicate that the notification message is due to one of a relay Uu RLF, relay handover, relay cell reselection, and/or relay connection failure.

In some embodiments of the present disclosure, a remote UE may be switched (or handed over) from an indirect path (e.g., the UE indirectly accesses a source BS (or source cell) via a source relay node) to a direct path (e.g., the UE directly accesses a target BS (or target cell) without any relay node) or to another indirect path (e.g., the UE indirectly accesses a target BS (or target cell) via a target relay node).

In some embodiments of the present disclosure, during the path switch (or handover), the UE may release the connection with the source cell (e.g., source BS) before the connection is established with the target cell (e.g., target BS). This may also be referred to as “hard handover”. As a result, the data transmission is stopped at the source cell before the UE starts to communicate with the target cell. This would cause an interruption which may be critical for services that are sensitive to latency or continuity. To overcome the above problem, a DAPS path switch (or DAPS handover) is introduced wherein a UE maintains the source cell connection after the reception of a handover command, and only releases the source cell connection after a successful access to the target cell. This may also be referred to as “soft handover”. The DAPS handover can be used to reduce or avoid the service interruption and thus to guarantee service continuity during the handover. This may require a UE to simultaneously receive and transmit data at both the source cell and target cell for a short period during the handover procedure. In the context of the present disclosure, “handover” and “path switch” may be used interchangeably.

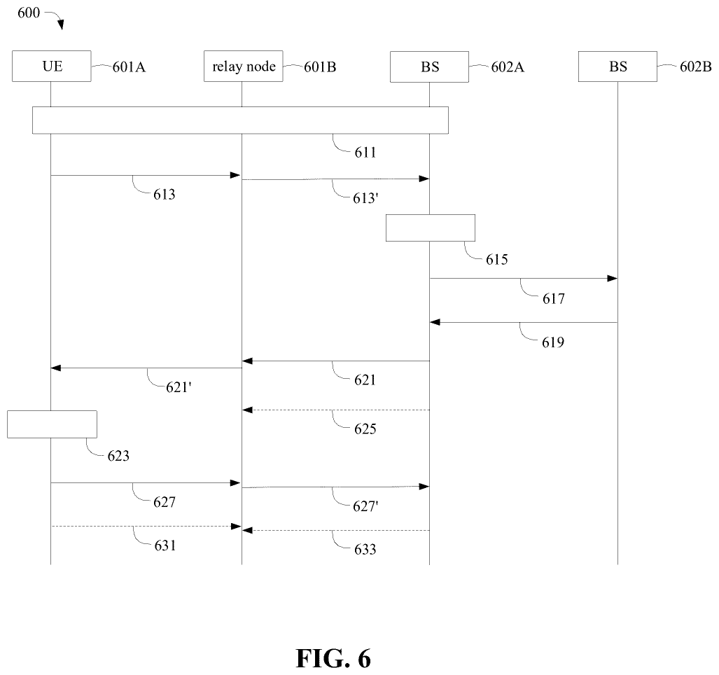

FIG. 4 illustrates a schematic diagram of wireless communication system 400 in accordance with some embodiments of the present disclosure. Details described in all of the foregoing embodiments of the present disclosure are applicable for the embodiments shown in FIG. 4.

Referring to FIG. 4, wireless communication system 400 may include some base stations (e.g., BS 402A and BS 402B) and some UEs (e.g., UE 401A and UE 401B). Although a specific number of UEs and BSs is depicted in FIG. 4, it is contemplated that any number of UEs and BSs may be included in the wireless communication system 400. In some examples, UE 401A may function as UE 201A shown in FIG. 2, UE 401B may function as UE 201B shown in FIG. 2, and BS 402A and BS 402B may function as BS 202 shown in FIG. 2.

UE 401A may communicate with BS 402A via UE 401B. BS 402A may decide to hand over UE 401A to BS 402B. As shown in FIG. 4, a DAPS handover may be performed. During the DAPS handover, UE 401A simultaneously maintain the source connection and target connection for a certain period.

Although it is shown in FIG. 4 that UE 401A is handed over via DAPS from an indirect path to a direct path, it is contemplated that UE 401A may be handed over via DAPS to another indirect path in some other embodiments of the present disclosure. For example, BS 402A may switch UE 401A to a target relay node (e.g., relay UE), which may access BS 402B.

It should be appreciated by persons skilled in the art that although some of the foregoing figures (e.g., FIGS. 2 and 4) are described with respect to a relay UE, it is contemplated that other types of relay nodes may be employed in place of the relay UE.

Various issues need to be solved during a DAPS handover of a remote UE. For example, solutions for handling the source relay node during the DAPS handover of the remote UE are needed. For example, during the DAPS handover, the remote UE may receive various messages from the relay node. Solutions for handling these messages are needed. For example, solutions for handling an RLF between the remote UE and source relay node during the DAPS handover are needed. More details on the embodiments of the present disclosure will be illustrated in the following text in combination with the appended drawings.

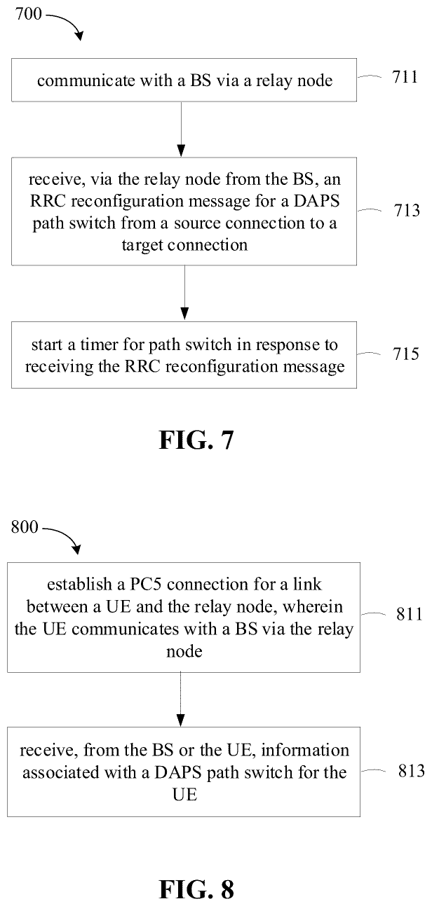

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, in operation 511, UE 501A may communicate with BS 502A via relay node 501B. In some embodiments, relay node 501B may be a UE (e.g., an L2 U2N relay UE). In some examples, UE 501A and relay node 501B may function as UE 401A and UE 401B shown in FIG. 4, and BS 502A and BS 502B may function as BS 402A and BS 402B shown in FIG. 4. The remote UE may be in a connected state (e.g., RRC_CONNECTED state).

In some embodiments, UE 501A may report a measurement result to BS 502A based on the configuration from BS 502A. The measurement result may include a measurement result for a cell or a candidate relay UE. For example, the measurement result may be transmitted from UE 501A to BS 502A via relay node 501B in operations 513 and 513′.

In some embodiments, UE 501A may report capability information to BS 502A. For example, the capability information may indicate whether UE 501A supports a DAPS path switch or not. The path switch could be from an indirect path to a direct path or from an indirect path to another indirect path. For example, the capability information may indicate at least one of the following: whether UE 501A supports a path switch from an indirect path to a direct path or not; or whether UE 501A supports a path switch from an indirect path to another indirect path or not.

In operation 515, BS 502A (source BS) may determine to switch UE 501A to a target cell (e.g., to a direct path) or a target relay UE (e.g., to an indirect path) via a DAPS path switch. In operation 517, BS 502A may transmit a handover request message to the target BS (e.g., BS 502B). In some embodiments, the handover request message may include information about UE 501A (e.g., the UE context and a UE ID).

In response to receiving the handover request message, BS 502B may admit the path switch, and may, in operation 519, transmit a handover request acknowledge message to BS 502A via, for example, an Xn interface. The handover request acknowledge message may include an RRC reconfiguration message.

In response to receiving the handover request acknowledge message, BS 502A may transmit an RRC reconfiguration message including a configuration with synchronization to UE 501A via relay node 501B in operations 521 and 521′. In the case of a DAPS path switch, the RRC reconfiguration message may also be referred to as an “RRC reconfiguration message for a DAPS path switch.”

In some embodiments, according to the reconfiguration message, some bearers may be configured as DAPS bearers. These bearers can include an end-to-end bearer or a PC5 bearer. The PC5 bearer may be associated with a PC5 relay RLC channel.

In some embodiments, for a non-DAPS bearer, UE 501A may perform a refresh of the security and a reestablishment of the RLC and packet data convergence protocol (PDCP) triggered by explicit L2 indicators.

In some embodiments, for a DAPS bearer, UE 501A may perform an establishment of the RLC for the target cell (e.g., the target primary cell (PCell)), a refresh of security and a reconfiguration of the PDCP to add the ciphering function, the integrity protection function and robust header compression (ROHC) function of the target cell (e.g., the target PCell).

It would be advantageous if relay node 501B is aware of the DAPS path switch. Relay node 501B can handle the buffered data for the non-DAPS bearer and DAPS bearer in different manners.

In some embodiments of the present disclosure, BS 502A may transmit information associated with the DAPS path switch to relay node 501B in operation 525 (denoted by a dotted arrow as an option). For example, the information may indicate whether a bearer associated with UE 501A and relay node 501B should be suspended or continued. In some embodiments, the information may include an indication indicating whether the bearer is associated with the DAPS path switch or not. In some embodiments, a corresponding indication per bearer associated with UE 501A and relay node 501B may be transmitted to relay node 501B. A bearer may be a DAPS bearer or a non-DAPS bearer depending on whether it is indicated as associated with the DAPS path switch or not. Such indication may also be referred to as a DAPS indication.

In response to receiving the information, relay node 501B may continue communications (e.g., transmitting or receiving data) associated with a DAPS bearer. Relay node 501B may release data associated with a non-DAPS bearer.

In response to receiving the RRC reconfiguration message, UE 501A may perform a path switch procedure. For example, UE 501A may start a timer for path switch in response to receiving the RRC reconfiguration message. The timer may be T304 as specified in 3GPP specifications in the case of switching to a target cell (e.g., a direct path) or T420 as specified in 3GPP specifications for switching to a target relay node (e.g., an indirect path).

In some embodiments of the present disclosure, a notification message may be received from relay node 501B when the timer for path switch is running. In some embodiments, relay node 501B may transmit the notification message in response to one of the following conditions: an RLF occurs between relay node 501B and the BS 502A; relay node 501B receives an RRC reconfigure message including a reconfiguration with synchronization (e.g., a handover command); relay node 501B (re) selects a cell; an RRC connection establishment failure or an RRC resume failure occurs at relay node 501B; relay node 501B initiates a reestablishment procedure; relay node 501B performs a successful reestablishment procedure; a reestablishment procedure fails at relay node 501B; and relay node 501B successfully performs a handover procedure.

In some embodiments of the present disclosure, in response to receiving the notification message when the timer for path switch is running, UE 501A may release the source connection (e.g., the connection to BS 502A). That is, although UE 501A is performing a DAPS handover, it may also release the source connection in this scenario.

In some embodiments of the present disclosure, UE 501A may detect an RLF of the sidelink between UE 501A and relay node 501B when the timer for path switch is running. In response to detecting the RLF when the timer for path switch is running, UE 501A may release the source connection (e.g., the connection to BS 502A).

In some embodiments of the present disclosure, in response to receiving the notification message when the timer for path switch is running, UE 501A may suspend the source connection (e.g., the connection to BS 502A). In some embodiments, when the connection (e.g., Uu link) between relay node 501B and BS 502A is available or recovered, UE 501A may resume the source connection.

In some embodiments of the present disclosure, BS 502A may inform relay node 501B that UE 501A performs a DAPS path switch. In response to receiving such information, relay node 501B may transmit a PC5 unicast link release indication (e.g., a PC5-S release message or a PC5-S message), instead of the notification message when a condition for transmitting the notification message is met. In this way, UE 501A would not receive a notification message when the timer for path switch is running, and may instead receive a PC5 unicast link release indication when the timer for path switch is running.

For example, in some embodiments, in operation 525, BS 502A may transmit an indication indicating that a DAPS path switch is performed at UE 501A to relay node 501B. In some embodiments, BS 502A may not transmit such an explicit indication. For example, the information indicating whether the bearer is associated with the DAPS path switch or not as described above may implicitly indicate that a DAPS path switch is performed at UE 501A. To put this another way, the information associated with the DAPS path switch to relay node 501B may indicate at least one of the following: whether a bearer associated with UE 501A and relay node 501B should be suspended or continued; or a DAPS path switch is performed at UE 501A.

In some embodiments of the present disclosure, UE 501A may receive a PC5 unicast link release indication when the timer for path switch is running. In response to receiving the PC5 unicast link release indication when the timer for path switch is running, UE 501A may release the source connection (e.g., the connection to BS 502A). In some examples, the PC5 unicast link release indication may be from an upper layer (e.g., PC5-S layer) of UE 501A. In some examples, the PC5 unicast link release indication may be transmitted by relay node 501B. For instance, as described above, in response to a condition for triggering a notification message is met, relay node 501B may transmit a PC5 unicast link release indication to UE 501A.

In operation 523, UE 501A may stop the timer for path switch. For example, when the target node of the handover is a cell, UE 501A may stop the timer for path switch (e.g., T304 as specified in 3GPP specifications) in response to a successful completion of the random access on the target cell. For example, when the target node of the handover is a relay node, UE 501A may stop the timer for path switch (e.g., T420 as specified in 3GPP specifications) in response to successfully transmitting an RRC reconfiguration complete message to the target BS (e.g., BS 502B) via the target relay node.

In some embodiments of the present disclosure, a notification message may be received from relay node 501B after the timer for path switch is stopped (e.g., before the source connection is released). The trigger conditions for a notification message as described above may also apply here.

In some embodiments of the present disclosure, in response to receiving the notification message after the timer for path switch is stopped, UE 501A may release the source connection (e.g., the connection to BS 502A). In some embodiments of the present disclosure, UE 501A may ignore the notification message received after the timer for path switch is stopped.

In some embodiments of the present disclosure, BS 502A may inform relay node 501B that UE 501A performs a DAPS path switch. For example, as described above with respect to operation 525, the information associated with the DAPS path switch to relay node 501B may indicate at least one of the following: whether a bearer associated with UE 501A and relay node 501B should be suspended or continued; or a DAPS path switch is performed at UE 501A. In response to receiving such information, relay node 501B may transmit a PC5 unicast link release indication (e.g., a PC5-S release message or a PC5-S message), instead of the notification message when a condition for transmitting the notification message is met. In this way, UE 501A would not receive a notification message after the timer for path switch is stopped, and may instead receive a PC5 unicast link release indication after the timer for path switch is stopped.

In some embodiments of the present disclosure, UE 501A may receive a PC5 unicast link release indication after the timer for path switch is stopped. In some embodiments of the present disclosure, in response to receiving the PC5 unicast link release indication after the timer for path switch is stopped, UE 501A may release the source connection (e.g., the connection to BS 502A). In some embodiments of the present disclosure, UE 501A may ignore the PC5 unicast link release indication received after the timer for path switch is stopped. In some examples, the PC5 unicast link release indication may be from an upper layer (e.g., PC5-S layer) of UE 501A. In some examples, the PC5 unicast link release indication may be transmitted by relay node 501B. For instance, as described above, in response to a condition for triggering a notification message is met, relay node 501B may transmit a PC5 unicast link release indication to UE 501A.

In some embodiments of the present disclosure, detecting whether an RLF occurs between UE 501A and relay node 501B or not after the timer for path switch is stopped may be allowed.

In some embodiments of the present disclosure, in response to UE 501A detecting an RLF of the sidelink between UE 501A and relay node 501B (or an RLF is declared) after the timer for path switch is stopped, UE 501A may release the source connection (e.g., the connection to BS 502A).

In some embodiments of the present disclosure, in response to UE 501A detecting an RLF of the sidelink between UE 501A and relay node 501B (or an RLF is declared) after the timer for path switch is stopped, UE 501A may not release the source connection (e.g., the connection to BS 502A). In other words, UE 501A may prohibit releasing the source connection in response to detecting the RLF.

In some embodiments of the present disclosure, UE 501A may not detect an RLF on the sidelink between UE 501A and relay node 501B after the timer for path switch is stopped. In other words, UE 501A may prohibit a detection of such RLF. In some embodiments of the present disclosure, prohibiting such RLF detection may include at least one of: prohibiting performing radio link monitoring (RLF); or prohibiting declaring an RLF in response to an expiry of a timer for sidelink RRC reconfiguration (T400 as specified in 3GPP specifications).

In operation 527, UE 501A may receive an RRC reconfiguration message from BS 502B. In some embodiments, an indication to release the source connection may be included in the RRC reconfiguration message.

In operation 529, in response to receiving the RRC reconfiguration message, UE 501A may release the source connection (e.g., if the source connection is not released). For example, UE 501A may release the PC5 RRC connection between UE 501A and relay node 501B and the Uu RRC configuration with the source cell (e.g., BS 502A).

It should be appreciated by persons skilled in the art that the sequence of the operations in exemplary procedure 500 may be changed and that some of the operations in exemplary procedure 500 may be eliminated or modified, without departing from the spirit and scope of the disclosure.

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, UE 601A may communicate with BS 602A via relay node 601B. In some embodiments, relay node 601B may be a UE (e.g., an L2 U2N relay UE). In some examples, UE 601A and relay node 601B may function as UE 401A and UE 401B shown in FIG. 4, and BS 602A and BS 602B may function as BS 402A and BS 402B shown in FIG. 4. The remote UE may be in a connected state (e.g., RRC_CONNECTED state).

In some embodiments, UE 601A may report a measurement result to BS 602A based on the configuration from BS 602A. The measurement result may include a measurement result for a cell or a candidate relay UE. For example, the measurement result may be transmitted from UE 601A to BS 602A via relay node 601B in operations 613 and 613′.

In some embodiments, UE 601A may report capability information to BS 602A. For example, the capability information may indicate whether UE 601A supports a DAPS path switch or not. The path switch could be from an indirect path to a direct path or from an indirect path to another indirect path. For example, the capability information may indicate at least one of the following: whether UE 601A supports a path switch from an indirect path to a direct path or not; or whether UE 601A supports a path switch from an indirect path to another indirect path or not.

In operation 615, BS 602A (source BS) may determine to switch UE 601A to a target cell (e.g., to a direct path) or a target relay UE (e.g., to an indirect path) via a DAPS path switch. In operation 617, BS 602A may transmit a handover request message to the target BS (e.g., BS 602B). In some embodiments, the handover request message may include information about UE 601A (e.g., the UE context and a UE ID).

In response to receiving the handover request message, BS 602B may admit the path switch, and may, in operation 619, transmit a handover request acknowledge message to BS 602A via, for example, an Xn interface. The handover request acknowledge message may include an RRC reconfiguration message.

In response to receiving the handover request acknowledge message, BS 602A may transmit an RRC reconfiguration message including a configuration with synchronization to UE 601A via relay node 601B in operations 621 and 621′. In the case of a DAPS path switch, the RRC reconfiguration message may also be referred to as an “RRC reconfiguration message for a DAPS path switch.”

In some embodiments, according to the reconfiguration message, some bearers may be configured as DAPS bearers. These bearers can include an end-to-end bearer or a PC6 bearer. The PC6 bearer may be associated with a PC6 relay RLC channel.

In some embodiments, for a non-DAPS bearer, UE 601A may perform a refresh of the security and a reestablishment of the RLC and packet data convergence protocol (PDCP) triggered by explicit L2 indicators.

In some embodiments, for a DAPS bearer, UE 601A may perform an establishment of the RLC for the target cell (e.g., the target primary cell (PCell)), a refresh of security and a reconfiguration of the PDCP to add the ciphering function, the integrity protection function and robust header compression (ROHC) function of the target cell (e.g., the target PCell).

It would be advantageous if relay node 601B is aware of the DAPS path switch. Relay node 601B can handle the buffered data for the non-DAPS bearer and DAPS bearer in different manners.

In some embodiments of the present disclosure, BS 602A may transmit information associated with the DAPS path switch to relay node 601B in operation 625 (denoted by a dotted arrow as an option). The information associated with the DAPS path switch as described above with respect to FIG. 5 may apply here. For example, the information may indicate whether a bearer associated with UE 601A and relay node 601B should be suspended or continued. In some embodiments, the information may include an indication indicating whether the bearer is associated with the DAPS path switch or not. In some embodiments, a corresponding indication per bearer associated with UE 601A and relay node 601B may be transmitted to relay node 601B. A bearer may be a DAPS bearer or a non-DAPS bearer depending on whether it is indicated as associated with the DAPS path switch or not. Such indication may also be referred to as a DAPS indication.

In response to receiving the information, relay node 601B may continue communications (e.g., transmitting or receiving data) associated with a DAPS bearer. Relay node 601B may release data associated with a non-DAPS bearer.

In response to receiving the RRC reconfiguration message, UE 601A may perform a path switch procedure. For example, UE 601A may start a timer for path switch in response to receiving the RRC reconfiguration message. The timer may be T304 as specified in 3GPP specifications in the case of switching to a target cell (e.g., a direct path) or T420 as specified in 3GPP specifications for switching to a target relay node (e.g., an indirect path).

In operation 623, the timer for path switch may expire. In some embodiments, UE 601A may fall back to the source connection in response to the expiry of the timer for path switch. In some embodiments, UE 601A may revert back to the UE configuration used in the source connection in response to the expiry of the timer for path switch. In some embodiments, UE 601A may perform data transmission or reception via the source connection after the fallback.

In some embodiments, UE 601A may transmit a failure indication of the DAPS path switch to BS 602A via relay node 601B in operations 627 and 627′. For example, the failure indication may be transmitted via a failure information message.

It would be advantageous if relay node 601B knows the fallback of UE 601A (e.g., the failure of the DAPS path switch or fallback of the DAPS path switch) such that relay node 601B can revert the configuration. In some embodiments of the present disclosure, BS 602A or UE 601A may inform relay node 601B of such information.

For example, in operation 631 (denoted by a dotted arrow as an option), UE 601A may transmit an indication indicating the fallback of UE 601A to relay node 601B. In some examples, the indication may be transmitted to relay node 601B via an RRC layer (e.g., RRC layer for PC5). In some examples, the indication may be transmitted to relay node 601B via a sidelink relay adaptation protocol (SRAP) layer.

For example, in operation 633 (denoted by a dotted arrow as an option), BS 602A may transmit information associated with the DAPS path switch to relay node 601B. The information may indicate the fallback of UE 601A and an ID of UE 601A. In some examples, the information may be transmitted to relay node 601B via an RRC message.

In response to receiving the indication indicating the fallback of UE 601A or the information, relay node 601B may revert a bearer not associated with the DAPS path switch (e.g., non-DAPS bearer) back to a source configuration (e.g., configuration used in the source connection).

It should be appreciated by persons skilled in the art that the sequence of the operations in exemplary procedure 600 may be changed and that some of the operations in exemplary procedure 600 may be eliminated or modified, without departing from the spirit and scope of the disclosure. For example, although operation 631 is shown after operation 627, it may precede operation 627 in some other embodiments. For example, the indication indicating the fallback of UE 601A may be transmitted in response to the expiry of the timer for path switch.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a UE (e.g., a remote UE).

Referring to FIG. 7, in operation 711, a UE may communicate with a BS via a relay node. In operation 713, the UE may receive, via the relay node from the BS, an RRC reconfiguration message for a DAPS path switch from a source connection to a target connection. In operation 715, the UE may start a timer for path switch (e.g., T304 or T420 as specified in 3GPP specifications) in response to receiving the RRC reconfiguration message.

In some embodiments of the present disclosure, the UE may perform at least one of the following: release the source connection in response to receiving a notification message from the relay node when the timer for path switch is running; release the source connection in response to detecting a radio link failure (RLF) of a sidelink between the UE and the relay node when the timer for path switch is running; release the source connection in response to receiving a PC5 unicast link release indication when the timer for path switch is running; suspend the source connection in response to receiving a notification message from the relay node when the timer for path switch is running; or resume the suspended source connection in response to the connection between the relay node and the BS becoming available.

In some embodiments of the present disclosure, the UE may stop the timer for path switch in response to a successful completion of random access on a target cell of the DAPS path switch or successfully transmitting an RRC reconfiguration complete message. The UE may perform at least one of the following after stopping the timer for path switch: release the source connection in response to receiving a notification message from the relay node; ignore a notification message received from the relay node; release the source connection in response to receiving a PC5 unicast link release indication; ignore a PC5 unicast link release indication; detect whether a radio link failure (RLF) occurs between the UE and the relay node or not; release the source connection in response to detecting an RLF of a sidelink between the UE and the relay node; prohibit releasing the source connection in response to detecting an RLF of a sidelink between the UE and the relay node; prohibit a detection of an RLF of a sidelink between the UE and the relay node; or release the source connection in response to receiving an RRC reconfiguration message from the target cell.

In some embodiments of the present disclosure, the PC5 unicast link release indication may be indicated by an upper layer of the UE or is received from the relay node.

In some embodiments of the present disclosure, prohibiting the detection of the RLF may include at least one of the following: prohibiting performing radio link monitoring; or prohibiting declaring an RLF in response to an expiry of a timer for sidelink RRC reconfiguration (e.g., T400 as specified in 3GPP specifications).

In some embodiments of the present disclosure, the notification message may be received in response to one of the following conditions: an RLF between the relay node and the BS; a reception of an RRC reconfiguration message including a configuration with synchronization at the relay node; a cell reselection at the relay node; an RRC connection establishment failure or an RRC resume failure at the relay node; an initiation of a reestablishment procedure at the relay node; a successful reestablishment procedure at the relay node; a failed reestablishment procedure at the relay node; and a successful handover of the relay node.

In some embodiments of the present disclosure, releasing the source connection may include releasing a PC5 RRC connection between the UE and the relay node.

In some embodiments of the present disclosure, the UE may perform at least one of the following: fall back to the source connection in response to an expiry of the timer for path switch; revert back to UE configuration used in the source connection; and transmit an indication indicating the fallback of the UE to the relay node. The indication may be transmitted to the relay node via an RRC layer or SRAP layer.

In some embodiments of the present disclosure, the UE may transmit capability information indicating whether the UE supports a DAPS path switch or not. The capability information may indicate at least one of the following: whether the UE supports a path switch from an indirect path to a direct path or not; or whether the UE supports a path switch from an indirect path to another indirect path or not.

It should be appreciated by persons skilled in the art that the sequence of the operations in exemplary procedure 700 may be changed and that some of the operations in exemplary procedure 700 may be eliminated or modified, without departing from the spirit and scope of the disclosure.

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. In some examples, the procedure may be performed by a relay node (e.g., a relay UE).

Referring to FIG. 8, in operation 811, a relay node may establish a PC5 connection for a link between a UE and the relay node, wherein the UE communicates with a BS via the relay node. In operation 813, the relay node may receive, from the BS or the UE, information associated with a DAPS path switch for the UE.

In some embodiments of the present disclosure, the information may be received from the BS, and may indicate at least one of the following: whether a bearer associated with the relay node and the UE should be suspended or continued; or a DAPS path switch is performed at the UE. In some embodiments, to indicate whether a bearer associated with the relay node and the UE should be suspended or continued, the information may include an indication indicating whether the bearer is associated with the DAPS path switch or not.

In some embodiments of the present disclosure, in response to receiving the information, the relay node may perform at least one of the following: continue communications associated with the bearer in the case that the information indicates that the bearer is associated with the DAPS path switch; or release data associated with the bearer in the case that the information indicates that the bearer is not associated with the DAPS path switch.

In some embodiments of the present disclosure, after receiving the information, the relay node may transmit a PC5 unicast link release indication (e.g., a PC5-S release message or a PC5-S message) to the UE in response to one of the following conditions: an RLF between the relay node and the BS; a reception of an RRC reconfiguration message including a configuration with synchronization at the relay node; a cell reselection at the relay node; an RRC connection establishment failure or an RRC resume failure at the relay node; an initiation of a reestablishment procedure at the relay node; a successful reestablishment procedure at the relay node; a failed reestablishment procedure at the relay node; and a successful handover of the relay node.

In some embodiments of the present disclosure, the information may be received from the UE and may indicate a fallback of the DAPS path switch. The information may be received from the UE via an RRC layer or SRAP layer.

In some embodiments of the present disclosure, the information may be received from the BS and may indicate a fallback of the DAPS path switch and an ID of the UE. The information may be received from the BS via an RRC message.

In some embodiments of the present disclosure, the relay node may revert a bearer not associated with the DAPS path switch back to a source configuration in response to receiving the information.

It should be appreciated by persons skilled in the art that the sequence of the operations in exemplary procedure 800 may be changed and that some of the operations in exemplary procedure 800 may be eliminated or modified, without departing from the spirit and scope of the disclosure.

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a BS.

Referring to FIG. 9, in operation 911, a BS may transmit, to a UE via a relay node, an RRC reconfiguration message for a DAPS path switch. In operation 913, the BS may transmit, to the relay node, information associated with the DAPS path switch.

In some embodiments of the present disclosure, the BS may receive capability information indicating whether the UE supports a DAPS path switch or not. The capability information may indicate at least one of the following: whether the UE supports a path switch from an indirect path to a direct path or not; or whether the UE supports a path switch from an indirect path to another indirect path or not.

In some embodiments of the present disclosure, the information may indicate at least one of the following: whether a bearer associated with the relay node and the UE should be suspended or continued; or a DAPS path switch is performed at the UE. In some embodiments, to indicate whether a bearer associated with the relay node and the UE should be suspended or continued, the information may include an indication indicating whether the bearer is associated with the DAPS path switch or not.

In some embodiments of the present disclosure, the BS may receive a failure indication of the DAPS path switch from the UE. The information may be transmitted in response to receiving the failure indication, and may indicate a fallback of the DAPS path switch and an ID of the UE. The information may be transmitted via an RRC message.

It should be appreciated by persons skilled in the art that the sequence of the operations in exemplary procedure 900 may be changed and that some of the operations in exemplary procedure 900 may be eliminated or modified, without departing from the spirit and scope of the disclosure.

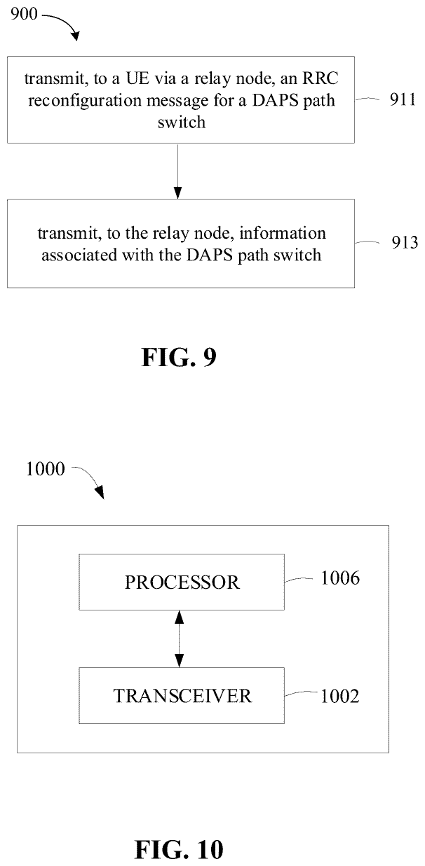

FIG. 10 illustrates a block diagram of exemplary apparatus 1000 according to some embodiments of the present disclosure.

As shown in FIG. 10, the apparatus 1000 may include at least one processor 1006 and at least one transceiver 1002 coupled to the processor 1006. The apparatus 1000 may be a BS, a relay node, or a UE.

Although in this figure, elements such as the at least one transceiver 1002 and processor 1006 are described in the singular, the plural is contemplated unless a limitation to the singular is explicitly stated. In some embodiments of the present application, the transceiver 1002 may be divided into two devices, such as a receiving circuitry and a transmitting circuitry. In some embodiments of the present application, the apparatus 1000 may further include an input device, a memory, and/or other components.

In some embodiments of the present application, the apparatus 1000 may be a UE. The transceiver 1002 and the processor 1006 may interact with each other so as to perform the operations with respect to the UEs described in FIGS. 1-9. In some embodiments of the present application, the apparatus 1000 may be a relay node. The transceiver 1002 and the processor 1006 may interact with each other so as to perform the operations with respect to the relay nodes described in FIGS. 1-9. In some embodiments of the present application, the apparatus 1000 may be a BS. The transceiver 1002 and the processor 1006 may interact with each other so as to perform the operations with respect to the BSs described in FIGS. 1-9.

In some embodiments of the present application, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UEs as described above. For example, the computer-executable instructions, when executed, cause the processor 1006 interacting with transceiver 1002 to perform the operations with respect to the UEs described in FIGS. 1-9.

In some embodiments of the present disclosure, the non-transitory computer-readable medium may have stored thereon computer-executable instructions to cause the processor 1006 to implement the method with respect to the relay nodes as described above. For example, the computer-executable instructions, when executed, cause the processor 1006 interacting with transceiver 1002 to perform the operations with respect to the relay nodes described in FIGS. 1-9.

In some embodiments of the present disclosure, the non-transitory computer-readable medium may have stored thereon computer-executable instructions to cause the processor 1006 to implement the method with respect to the BSs as described above. For example, the computer-executable instructions, when executed, cause the processor 1006 interacting with transceiver 1002 to perform the operations with respect to the BSs described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
communicate with a base station (BS) via a relay node;
receive, via the relay node from the BS, a radio resource control (RRC) reconfiguration message for a dual active protocol stack (DAPS) path switch from a source connection to a target connection; and
start a timer for path switch in response to receiving the RRC reconfiguration message.

2. The UE of claim 1, wherein the at least one processor is further configured to cause the UE to:
release the source connection in response to receiving a notification message from the relay node when the timer for the path switch is running;
release the source connection in response to detecting a radio link failure (RLF) of a sidelink between the UE and the relay node when the timer for the path switch is running;
release the source connection in response to receiving a PC5 unicast link release indication when the timer for the path switch is running;
suspend the source connection in response to receiving a notification message from the relay node when the timer for the path switch is running; or
resume the suspended source connection in response to the connection between the relay node and the BS becoming available.

3. The UE of claim 1, wherein the at least one processor is further configured to cause the UE to:
stop the timer for the path switch in response to a successful completion of random access on a target cell of the DAPS path switch or in response to successfully transmitting an RRC reconfiguration complete message; and
after stopping the timer for the path switch:
release the source connection in response to receiving a notification message from the relay node;
ignore a notification message received from the relay node;
release the source connection in response to receiving a PC5 unicast link release indication;
ignore a PC5 unicast link release indication;
detect whether a radio link failure (RLF) occurs between the UE and the relay node er net;
release the source connection in response to detecting an RLF of a sidelink between the UE and the relay node;
prohibit releasing the source connection in response to detecting an RLF of a sidelink between the UE and the relay node;
prohibit a detection of an RLF of a sidelink between the UE and the relay node; or
release the source connection in response to receiving an RRC reconfiguration message from the target cell.

4. The UE of claim 2, wherein the PC5 unicast link release indication is indicated by an upper layer of the UE or is received from the relay node.

5. The UE of claim 3, wherein prohibiting the detection of the RLF comprises at least one of the following:
prohibiting performing radio link monitoring; or
prohibiting declaring an RLF in response to an expiry of a timer for sidelink RRC reconfiguration.

6. The UE of claim 2- or 3, wherein the notification message is received in response to one of the following conditions:
an RLF between the relay node and the BS;
a reception of an RRC reconfiguration message including a configuration with synchronization at the relay node;
a cell reselection at the relay node;
an RRC connection establishment failure or an RRC resume failure at the relay node;
an initiation of a reestablishment procedure at the relay node;
a successful reestablishment procedure at the relay node;
a failed reestablishment procedure at the relay node; and
a successful handover of the relay node.

7. The UE of claim 2, wherein releasing the source connection comprises releasing a PC5 RRC connection between the UE and the relay node.

8. The UE of claim 1, wherein the at least one processor is further configured to cause the UE to:
fall back to the source connection in response to an expiry of the timer for the path switch;
revert back to a UE configuration used in the source connection; or
transmit an indication indicating the fallback of the UE to the relay node.

9. The UE of claim 8, wherein the indication is transmitted to the relay node via an RRC layer or sidelink relay adaptation protocol (SRAP) layer.

10. The UE of claim 1, wherein the at least one processor is further configured to cause the UE to transmit capability information indicating whether the UE supports a DAPS path switch.

11. The UE of claim 10, wherein the capability information indicates at least one of the following:
whether the UE supports a path switch from an indirect path to a direct path; or
whether the UE supports a path switch from an indirect path to another indirect path.

12. A relay node for wireless communication, comprising:
at least one memory; and
at least one processor coupled with the at least one memory and configured to cause the relay node to:
establish a PC5 connection for a link between a user equipment (UE) and the relay node, wherein the UE communicates with a base station (BS) via the relay node; and
receive, from the BS or the UE, information associated with a dual active protocol stack (DAPS) path switch for the UE.

13. The relay node of claim 12, wherein the information is received from the BS, and indicates at least one of the following:
whether a bearer associated with the relay node and the UE should be suspended or continued; or
performance of a DAPS path switch at the UE.

14. A base station (BS) for wireless communication, comprising:
at least one memory; and
at least one processor coupled with the at least one memory and configured to cause the BS to:
transmit, to a user equipment (UE) via a relay node, a radio resource control (RRC) reconfiguration message for a dual active protocol stack (DAPS) path switch; and
transmit, to the relay node, information associated with the DAPS path switch.

15. The BS of claim 14, wherein the information indicates at least one of the following:
whether a bearer associated with the relay node and the UE should be suspended or continued; or
performance of a DAPS path switch at the UE.

16. The BS of claim 14, wherein the at least one processor is further configured to cause the BS to receive capability information indicating whether the UE supports a DAPS path switch.

17. The BS of claim 16, wherein the capability information indicates at least one of the following:
whether the UE supports a path switch from an indirect path to a direct path; or
whether the UE supports a path switch from an indirect path to another indirect path.

18. The BS of claim 16, wherein the at least one processor is further configured to cause the BS to receive a failure indication of the DAPS path switch from the UE; and
wherein the information associated with the DAPS path switch indicates a fallback of the DAPS path switch and an ID of the UE.

19. A processor for wireless communication, comprising:
at least one controller coupled with at least one memory and configured to cause the processor to:
communicate with a base station (BS) via a relay node;
receive, via the relay node from the BS, a radio resource control (RRC) reconfiguration message for a dual active protocol stack (DAPS) path switch from a source connection to a target connection; and
start a timer for path switch in response to receiving the RRC reconfiguration message.

20. The processor of claim 19, wherein the at least one controller is further configured to cause the processor to:
fall back to the source connection in response to an expiry of the timer for the path switch;
revert back to a configuration used in the source connection; or
transmit an indication indicating the fallback of the processor to the relay node.
